(19) United States
(12) Patent Application Publication
(10) Pub. No.: US 2021/0190425 A1
(43) Pub. Date: Jun. 24, 2021

(54) SPRAY FREEZE DRYING ON A SUBSTRATE

(71) Applicant: IMA LIFE NORTH AMERICA INC., Tonawanda, NY (US)

(72) Inventors: ARNAB GANGULY, Williamsville, NY (US); FRANCIS W. DEMARCO, Niagara Falls, NY (US); ERNESTO RENZI, Youngstown, NY (US)

(21) Appl. No.: 16/762,596

(22) PCT Filed: Nov. 22, 2017
(86) PCT No.: PCT/US2017/062939

§ 371 Date: May 8, 2020

(51) Int. Cl. F26B 5/06; F26B 17/02; F26B 25/00; F26B 5/04

(52) U.S. Cl. CPC F26B 5/065; F26B 5/04; F26B 25/008; F26B 17/023

(57) ABSTRACT

A freeze dryer processes a bulk material including a liquid, and produces a product including the freeze dried material borne on a substrate. The material is introduced in a freezing chamber as a droplet stream that impinges on the substrate. The liquid in the material is frozen after it contacts the substrate. The substrate bearing the material is transferred through a vacuum lock into a vacuum drying chamber where the frozen liquid sublimates under vacuum and applied heat.

### FIELD OF THE INVENTION

The present invention relates generally to freeze drying processes and equipment for removing moisture from a product using sublimation. More specifically, the invention relates to processes and equipment for producing a product including a freeze-dried material borne on a substrate.

### BACKGROUND

Freeze drying is a process that removes a solvent or suspension medium, typically water, from a product. While the present disclosure uses water as the exemplary solvent, other solvents, such as alcohol, may also be removed in freeze drying processes and may be removed with the presently disclosed methods and apparatus.

In a freeze drying process for removing water, the water in the product is frozen to form ice and, under vacuum, the ice is sublimed and the vapor flows towards a condenser. The water vapor is transferred to the condenser and is later removed from the condenser as ice. Freeze drying is particularly useful in the pharmaceutical industry, as the integrity of the product is preserved during the freeze drying process and product stability can be guaranteed over relatively long periods of time. The freeze dried product is ordinarily, but not necessarily, a biological substance.

Pharmaceutical freeze drying is often an aseptic process that requires sterile conditions within the freeze drying system. In that case, it is critical to assure that all components of the freeze drying system coming into contact with the product are sterile.

In one example of a prior art freeze drying system 100 shown in FIG. 1, a batch of product 112 is placed in freeze dryer trays 121 within a freeze drying chamber 110. Freeze dryer shelves 123 are used to support the trays 121 and to transfer heat to and from the trays and the product as required by the process. A heat transfer fluid flowing through conduits within the shelves 123 is used to remove or add heat.

Under vacuum, the frozen product 112 is heated slightly to cause sublimation of the ice within the product. Water vapor resulting from the sublimation of the ice flows through a passageway 115 into a condensing chamber 120 containing condensing coils or other surfaces 122 maintained below the condensation temperature of the water vapor. A coolant is passed through the coils 122 to remove heat, causing the water vapor to condense as ice on the coils.

Both the freeze drying chamber 110 and the condensing chamber 120 are maintained under vacuum during the process by a vacuum pump 150 connected to the exhaust of the condensing chamber 120. Non-condensable gases contained in the chambers 110, 120 are removed by the vacuum pump 150 and exhausted at a higher pressure outlet 152.

Bulk product to be freeze dried in a tray dryer must be manually loaded into the trays, freeze dried, and then manually removed from the trays. Handling the trays is difficult, and creates the risk of a liquid spill. Bulk product that has been freeze dried in a tray dryer must subsequently be handled for packaging, resulting in product handling loss.

Spray freeze drying has been suggested, wherein a liquid substance is sprayed into a low temperature environment, and water in the resulting frozen particles is sublimated by exposing the falling particles to radiant heat (see, e.g., U.S. Pat. No. 3,300,868). That process is limited to materials from which water may be removed rapidly, while the particles are airborne, and requires radiant heaters in a low temperature environment, reducing efficiency. Post-process handling and packaging is necessary. The spraying mechanism can be difficult to sterilize, making the implementation challenging.

There is a need for freeze drying techniques and equipment that may be wherein bulk material may be handled in as aseptic manner and post-processing of the product for packaging is minimized. The process should be as continuous as possible, avoiding product transfer between equipment wherever possible and minimizing human intervention.

### SUMMARY

The present disclosure addresses the needs described above by providing a freeze drying system for freeze drying a bulk product containing a liquid. The system includes a freezing chamber; and at least one bulk product inlet directed to an interior of the freezing chamber. The at least one bulk product inlet is connected to a source of the bulk product, and the at least one bulk product inlet is configured to create at least one droplet stream of the bulk product in the interior of the freezing chamber.

The system further includes at least one substrate feeding mechanism configured to feed a substrate to a first position in the interior of the freezing chamber, where the at least one droplet stream impinges on the substrate. A substrate chiller is configured to chill the substrate to below a freezing point of the liquid at the first position, whereby the liquid freezes after the at least one droplet stream impinges on the substrate to form a frozen liquid.

The system additionally includes a vacuum drying chamber and a first vacuum lock interconnecting the freezing chamber with the vacuum drying chamber. The at least one substrate feeding mechanism is further configured to feed the substrate through the first vacuum lock to an interior of the vacuum drying chamber. A vacuum pump is in communication with the vacuum drying chamber for maintaining a vacuum pressure in the vacuum drying chamber to promote sublimation of the frozen liquid. A heater in the vacuum drying chamber may direct heat to the substrate to further promote sublimation.

Another embodiment of the invention is a method for freeze drying a bulk product containing a liquid. At least one droplet stream of the bulk product is formed in an interior of a freezing chamber. A substrate is fed to a first position in the interior of the freezing chamber where the at least one droplet stream impinges on the substrate.

The substrate is chilled at the first position to below a freezing point of the liquid, whereby the liquid freezes to produce a frozen liquid on the substrate after the at least one droplet stream impinges on the substrate. The substrate is fed through a vacuum lock into a vacuum drying chamber, and the substrate in the vacuum drying chamber is subjected to a vacuum pressure to promote sublimation of the frozen liquid. Heat may be directed to the substrate to further promote sublimation.

### BRIEF DESCRIPTION OF THE DRAWINGS

FIG. 1 is a schematic drawing of a prior art freeze drying system.

FIG. 2 is a schematic drawing of an inlet or nozzle system according to one embodiment of the disclosure.

FIG. 3 is a schematic drawing of a freeze drying system according to another embodiment of the disclosure.

FIG. 3a is a schematic partial plan view of the freeze drying system of FIG. 3, showing one inlet or nozzle arrangement according to an embodiment of the disclosure.

FIG. 4 is a schematic drawing of a freeze drying system according to another embodiment of the disclosure.

FIG. 4a is a schematic partial plan view of the freeze drying system of FIG. 4, showing an alternate conveying device according to an embodiment of the disclosure.

FIG. 4b is a schematic partial plan view of the freeze drying system of FIG. 4, showing another alternate conveying device according to an embodiment of the disclosure.

FIG. 5 is a schematic drawing of a spraying system according to one embodiment of the disclosure.

FIG. 6 is a flow chart showing a method in accordance with one aspect of the disclosure.

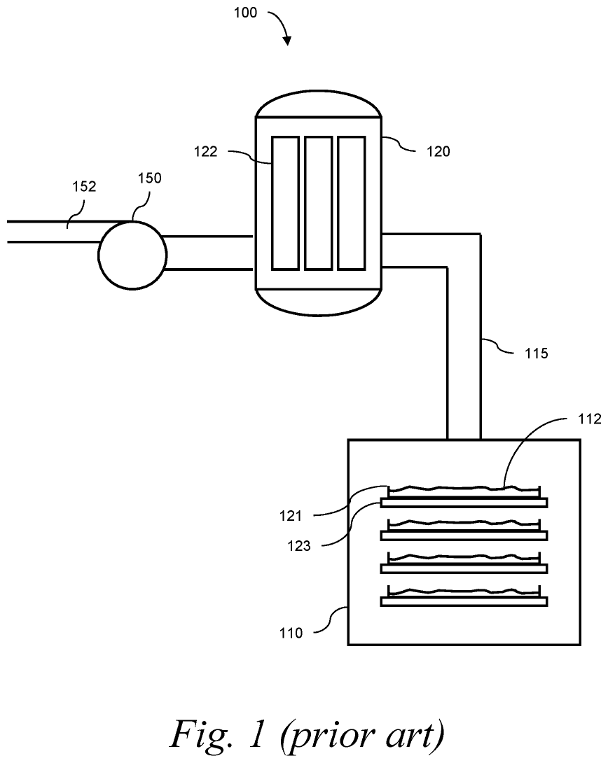

### DESCRIPTION

The presently described processes and apparatus are directed to the application of freeze dried materials to a substrate to produce an end product. For example, drugs for oral administration may take the form of a freeze dried pharmaceutical material deposited on an edible substrate such as an edible, hydrophylic paper or soluble polymer film. A single, precise dose of a single drug may be carried by the substrate. The dose may be customized for a particular patient or medical condition. Multiple doses may be carried on separable sections of a substrate, such as perforated sections. In another example, doses of multiple drugs may be carried on a single edible substrate, customized for an individual patient. The use of a single delivery system for multiple drugs simplifies dosing.

In another example, freeze dried laboratory test reagents may be deposited in an array of test wells on a well plate substrate. Such well plates may be used in diagnostic testing where multiple reagents are used in analyzing a single sample. The well plate substrate may be extremely small, minimizing the required sample size.

In a further example, pharmaceuticals or diagnostic materials may be applied to a “patch” substrate to be adhered to the skin of a patient for transdermal use. The substrate may include an adhesive for securing to the skin. The material applied to the substrate may be one or more pharmaceutical materials applied in precise dosages to be absorbed through the skin. The material may alternatively be one or more reagents arranged in an array or pattern to react with substances received through the skin. For example, the reagent may change color depending on characteristics of the received sub stance.

The present disclosure describes systems and methods in which the freeze drying of bulk materials is integrated with the application of those materials to a substrate. Those systems and methods greatly reduce the intermediate material handling steps that would otherwise be necessary to apply the freeze dried material to a substrate. In certain embodiments, because the bulk material is applied to the substrate before the liquid is removed by sublimation, the bulk material may be absorbed by an absorbent substrate or dried directly on a surface of a film-like substrate, integrating the bulk product with the substrate.

The processes and apparatus may advantageously be used in drying pharmaceutical products that require aseptic or sterile processing, such as reagents and oral or transdermal drugs. The methods and apparatus may also be used, however, in processing materials that do not require aseptic processing, but require moisture removal while preserving structure in the freeze dried material as it is applied to the substrate. For example, the disclosed techniques may be used in processing ceramic/metallic products used as superconductors or for forming nanoparticles or microcircuit heat sinks.

The systems and methods described herein may be performed in part by an industrial controller and/or computer used in conjunction with the processing equipment described below. The equipment is controlled by a programmable logic controller (PLC) that has operating logic for valves, motors, etc. An interface with the PLC is provided via a PC. The PC loads a user-defined recipe or program to the PLC to run. The PLC will upload to the PC historical data from the run for storage. The PC may also be used for manually controlling the devices, operating specific steps such as freezing, defrost, steam in place, etc.

The PLC and the PC include central processing units (CPU) and memory, as well as input/output interfaces connected to the CPU via a bus. The PLC is connected to the processing equipment via the input/output interfaces to receive data from sensors monitoring various conditions of the equipment such as temperature, pressure, position, speed, flow, etc. The PLC is also connected to operate devices that are part of the equipment.

The memory may include random access memory (RAM) and read-only memory (ROM). The memory may also include removable media such as a memory stick, etc. The RAM may function as a data memory that stores data used during execution of programs in the CPU, and is used as a work area. The ROM may function as a program memory for storing a program including the steps executed in the CPU. The program may reside on the ROM, and may be stored on the removable media or on any other non-volatile computer-usable medium in the PLC, PC, or in a remotely accessible server, as computer readable instructions stored thereon for execution by the CPU or other processor to perform the methods disclosed herein.

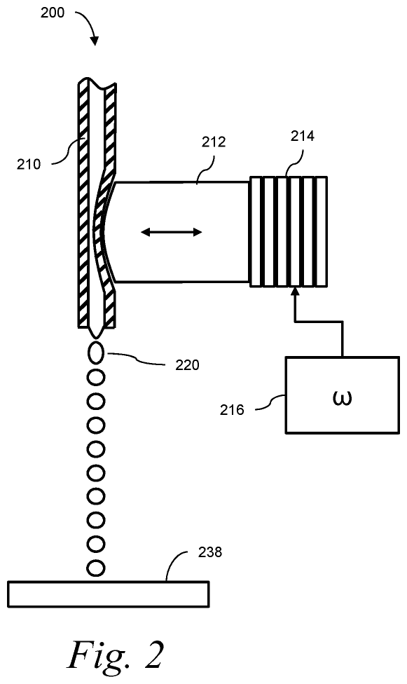

The presently described methods and apparatus may utilize a piezoelectric nozzle system such as the system 200 shown in FIG. 2. That system may include a flexible polymer tube 210 to conduct the bulk material to be freeze dried into a freezing chamber from a source of the bulk material. An internal volume of the flexible polymer tube 210 is changed by a piston 212 actuated by a piezoelectric stack 214 to deform the tube. The bulk material is ejected from the tube in droplets 220, which impinge on a substrate 238. By changing flowrate of material through the tube 210 and a frequency at which a controller 216 actuates the piezoelectric stack 214, a size and frequency of the droplets 220 may be accurately controlled. Such a nozzle system is available from BioFluidics GmbH, Engesserstr. 4a, 79108 Freiburg, Germany.

The nozzle or inlet system 200 may be configured to permit the flexible polymer tube 210 to be easily replaced under sanitary or sterile conditions. The relatively inexpensive flexible polymer tube 210 is the only component of the system 200 that contacts the bulk product and extends into the freezing chamber. The tube may therefore be changed between batches or between runs of a particular product, permitting the system 200 to be used in freeze drying materials requiring sanitary or sterile conditions.

In an alternate embodiment, the bulk material may in introduced into the freezing chamber through a stainless steel or other metallic capillary that is vibrated by a piezoelectric or other actuator to produce a droplet stream. In yet another embodiment, the bulk product may be sprayed into the freezing chamber using an orifice-type nozzle or an ultrasonic atomizing nozzle. Those embodiments are steam sterilized between batches or between runs.

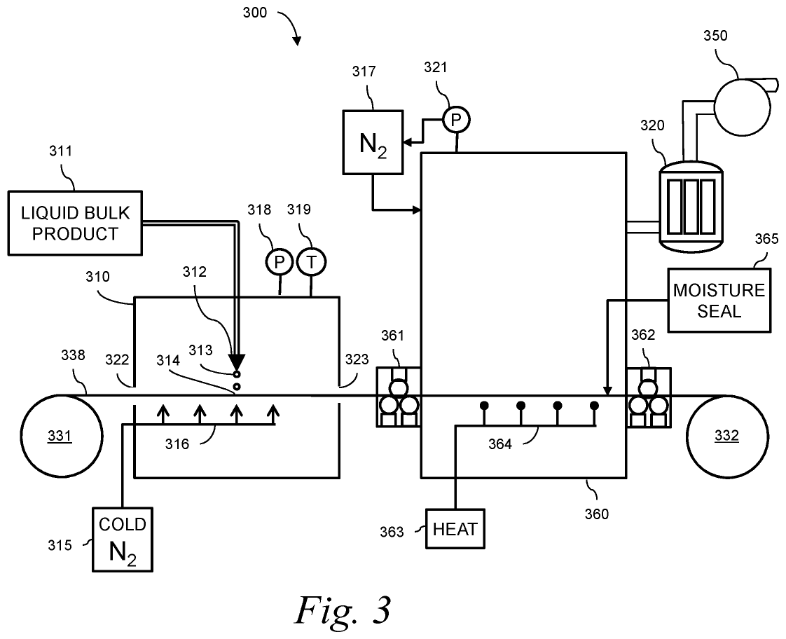

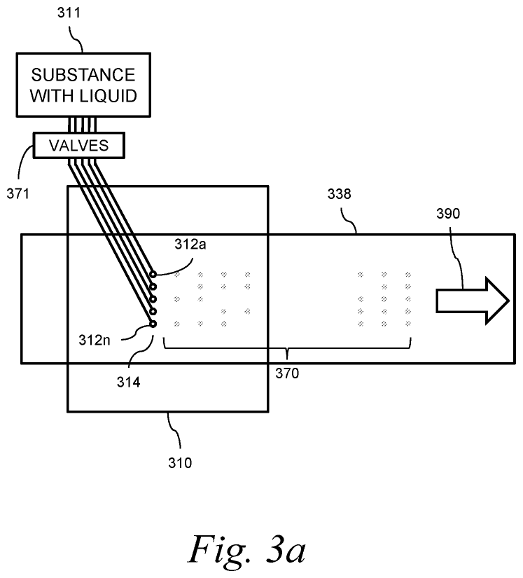

An exemplary system 300 in accordance with one disclosed embodiment is shown in FIG. 3. The system 300 includes a freezing chamber 310 and a drying chamber 360. A bulk product including a liquid to be removed from the bulk product is introduced from a source 311 into the freezing chamber 310 through one or more inlets or nozzles 312.

The inlet 312 forming the individual droplets 313 of bulk product may be a nozzle arrangement 200 as described with reference to FIG. 2. Alternatively, the droplets may be formed by a droplet-on-demand system such as those commonly used in ink jet printing technology. Those systems include nozzles in which the material is ejected by displacing a volume using a piezoelectric actuator. Droplet-on-demand systems further include thermal print heads in which the material is ejected by vaporizing it inside a restricted volume. While droplet-on-demand systems present challenges in maintaining a sterile or sanitary environment and in maintaining the integrity of the freeze dried product, they may have advantages over the nozzle arrangement 200 of FIG. 2 regarding accuracy of drop trajectory and control over volumetric output.

The liquid bulk product forms droplets 313 inside the freezing chamber 310 that impinge on a region 314 of a substrate 338 within the chamber 310. In the embodiment 300 shown in FIG. 3, the substrate 338 is a flexible substrate in the form of a web that is fed from a source roll 331 to a take-up roll 332. The substrate 338 may, for example, be an absorbent, edible paper or a polymeric film on which is deposited one of more pharmaceutical substances. The pharmaceutical substances, together with the substrate, may be for ingesting by the patient. Multiple nozzles 312 may deposit multiple pharmaceutical substances on a single substrate, to create a customized product containing multiple medications to be taken by a particular patient as a single dose.

An array of nozzles 312a . . . 312n, shown in FIG. 3a, may be used to increase throughput and to permit the creation of two dimensional patterns of one or more freeze dried materials on a substrate within the freezing chamber 310. The supply of bulk product from the source 311 to the nozzles may be controlled by an arrangement of valves 371 or by droplet-on-demand systems to form a pattern 370 on the substrate 338. As bulk product is deposited on the substrate 338 in the region 314, the substrate is moved or indexed in a direction 390.

While the nozzles 312a . . . 312n are shown connected to a common source 311 of bulk product, the nozzles may alternatively be supplied by different sources, and carry different bulk products. In that case, multiple, different bulk products may be deposited on the substrate in a pattern.

Returning to FIG. 3, the freezing chamber 310 includes a temperature controller 319 and pressure controller 318 for monitoring conditions inside the chamber 310 and adjusting temperature and pressure accordingly. In one embodiment, clean, cold air or sterile nitrogen gas is maintained within the chamber at a pressure approximating atmospheric pressure. The air temperature in the freezing chamber is maintained sufficiently high to prevent the droplets 313 from freezing as they travel from the nozzle 312 to the region 314 on the substrate 338. Maintaining such a temperature minimizes waste causes by frozen particles bouncing from the substrate, and minimizes clogging of the nozzles caused by frozen product. In the case where the substrate is a hydrophilic material, the liquid bulk material is absorbed by the substrate, resulting in a fully integrated end product. In the case where the substrate is a polymer film or a less absorbent material, the liquid bulk material remains partially or completely separate from the substrate may be a deposit on a surface of the substrate.

The substrate may be fed from the source roll 331 to the take-up roll 332 in a continuous motion, or may be indexed intermittently to allow for deposition of the droplets 313 while the substrate is at rest. To cause the droplets to freeze after contacting the substrate, the substrate 338 is cooled. Cooling the substrate may be accomplished, for example, by applying cold nitrogen gas 315 or a liquid nitrogen spray to the substrate using a manifold 316 in proximity with the substrate 338. Sterilized liquid nitrogen (LN2) may be used. The use of sterile LN2 as the cold source makes possible the direct contact of aseptic substrate with the cold source or freezing agent, without contamination.

The substrate may be cooled before it reaches the region 314 where the droplets 313 impinge, causing the droplets to freeze upon contact. In that case, the substrate maybe cooled, for example, to −50° C. or lower before the droplets reach the substrate. Alternatively, the substrate may be cooled downstream of the region 314, delaying the freezing of the droplets until after they are absorbed by or settle upon the substrate.

In the embodiment 300 shown in FIG. 3, the substrate web 338 must enter and exit the freezing chamber 310 through openings 322, 323 in walls of the chamber. In the case where a sterile environment is required, the source roll 331 is contained within a clean enclosure that connects to or encloses the freezing chamber 310 and protects the substrate web 338 entering and exiting the freezing chamber 310 from contamination.

The system 300 additionally includes a vacuum drying chamber 360 in which sublimation of the frozen liquid occurs. To promote sublimation, the vacuum drying chamber 360 is maintained at a vacuum pressure by a vacuum pump 350. Between the vacuum pump 350 and the chamber 360 is a condensing chamber 320. Vapor forming from sublimation of the liquid is moved by the vacuum pump 350 into the condensing chamber 320 where it is condensed as ice and is periodically removed. Non-condensable gases contained in the vacuum drying chamber 360 and the condensing chamber 320 are removed by the vacuum pump 550 and exhausted.

Pressure within the vacuum drying chamber 360 is monitored by a pressure measurement device 321. In one embodiment, the vacuum pump 350 is a roughing vacuum pump run at constant speed. If pressure in the chamber 360 is too low, sterile nitrogen gas 317 or another clean gas is bled into the chamber to maintain the pressure within a predetermined range.

The substrate web 338 enters and exits the vacuum drying chamber 360 through vacuum locks such as vacuum chamber seals 361, 362 to maintain a pressure differential between the interior and exterior of the chamber. As used herein, the term “vacuum lock” refers to a device that isolates the pressure inside the vacuum drying chamber from the ambient outside pressure, while allowing the substrate to enter or exit the vacuum chamber. The vacuum chamber seals 361, 362 may, for example, be of a guide roll type of vacuum seal wherein a seal is created by contact of the web with one or more guide rolls. Other sealing techniques are known.

In addition to subjecting the frozen product to vacuum pressure, heat 363 is added to the frozen product in the vacuum chamber by a heat transfer device 364 to promote sublimation. In one example, radiant heat in the form of infrared radiation is applied to the substrate by infrared sources. In another example, a heated fluid is circulated through a heat exchanger proximate the substrate. In another example, radio frequency waves such as microwaves, or other electromagnetic radiation, may be used to heat the substrate.

A moisture seal 365 may be applied to the substrate to prevent the return of moisture to the freeze dried product when it leaves the vacuum drying chamber 360. The moisture seal may, for example, be a sprayed hydrophobic coating, or may be a sealing overwrap applied to the product before it emerges from the vacuum drying chamber. In the case of transdermal products deposited on a patch material, a skin adhesive may similarly be applied.

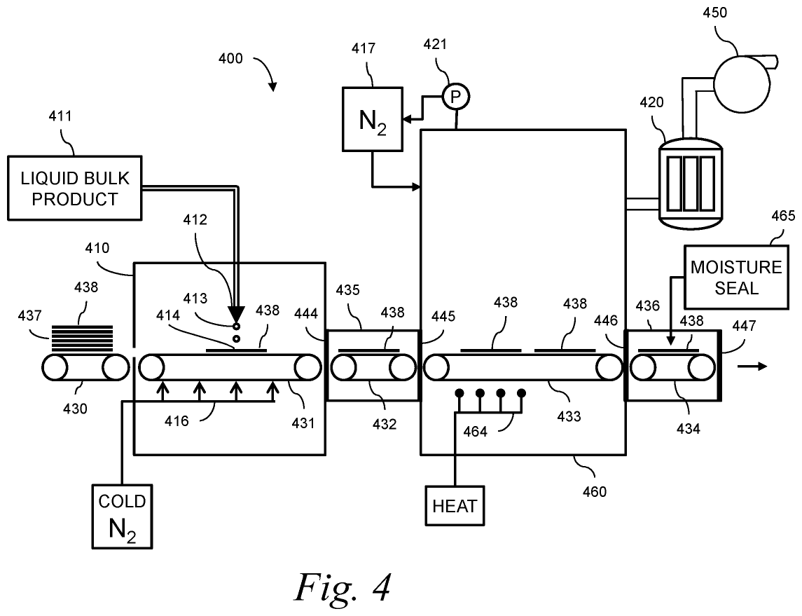

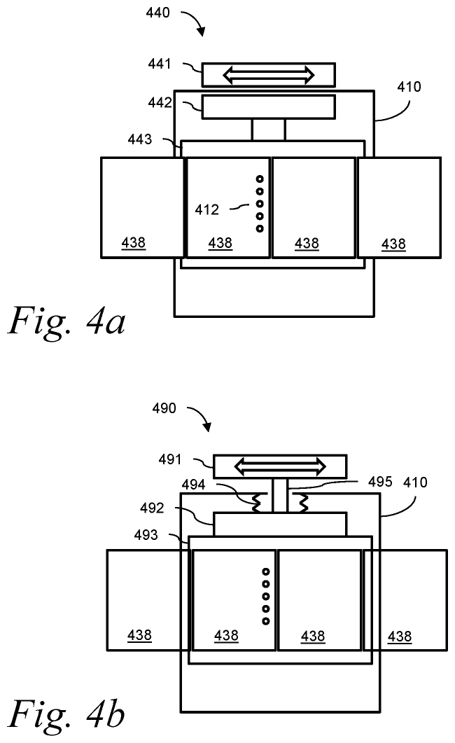

In another system 400 in accordance with the disclosure, shown in FIG. 4, liquid bulk product from a source 411 is deposited as droplets 413 on individual substrate elements 438. The individual substrate elements 438 may, for example, be well plates for holding an array of one or more freeze dried reagents for use in diagnostic testing. Well plates may comprise polymer plates having arrays of indentations in which freeze dried reagents are deposited. The final well plate product also includes an overwrap and/or a foil covering to prevent biological contamination and to serve as a moisture barrier.

In the system 400, the individual substrate elements 438 are fed from a substrate stack 437. They may be fed by a conveying device 430 such as a conveyor belt arrangement, as shown in FIG. 4, or another conveying device, such as a vibratory conveyor. The individual substrate elements 438 enter a freezing chamber 410 in which liquid bulk product is directed through an inlet 412 to form droplets 413 that impinge on a region 414 of the individual substrate elements 438.

As described above, the drops may reach the substrate as a liquid, and freeze after contact with the substrate. The atmosphere in the freezing chamber may be maintained at a temperature sufficiently high to postpone freezing until after the drops reach the substrate, and the substrate may be cooled by a cooling apparatus 416 to promote freezing of the bulk product on the substrate.

The individual substrate elements 438 are moved through the freezing chamber 410 using a conveying device 431 such as a conveyor belt. An alternative conveying device, such as a vibratory conveyor 440 shown in FIG. 4a, may be used. In that case, a vibration generator 441 is positioned outside the freezing chamber 410 and transmits vibrations through a magnetic coupling to an element 442 within the chamber. A shelf 443 or other supporting element is thereby vibrated, transferring the individual substrate elements 438 through the freezing chamber 410 and past the bulk product inlets 412.

Another vibratory conveying device 490, shown in FIG. 4b, uses bellows 494 to separate a vibration generator 491 and a mechanical vibration transfer element 495 from the interior of the freezing chamber 410. The mechanical vibration transfer element 495 mechanically connects a shelf 493 and bulkhead 492 to the vibration generator 491. The shelf 493 is thereby vibrated, transferring the individual substrate elements 438 through the freezing chamber 410.

The system 400 may include a plurality of inlets 412 for directing drops of a plurality of bulk products or drops of the same bulk product into a line on the individual substrate, as shown in FIG. 3a. In one example, a plurality of reagents to be freeze dried are directed onto a line of indentations in a well plate. The individual substrate elements 438 may be indexed through the freezing chamber 410, stopping at positions where the inlets are in registration with target locations on the substrate, such as wells of a well plate.

Droplets of the bulk product are frozen on the substrate in the freezing chamber as described above with reference to FIG. 3. The individual substrate elements 438 with frozen bulk product are then transferred into a vacuum lock such as the vacuum lock chamber 435 including a conveying device 432. The vacuum lock chamber 435 includes pressure barriers 444, 445 such as doors that may be selectively opened and closed to equalize pressure in the vacuum lock chamber 435 with either the atmospheric pressure of the freezing chamber 410 or the vacuum pressure of the vacuum drying chamber 460. After the barrier 444 is closed and the barrier 445 is opened to evacuate the vacuum lock chamber 435, the individual substrate elements 438 are transferred into the vacuum drying chamber 460. The substrate elements may move through the vacuum lock chamber individually, or, in the alternative, the vacuum lock chamber doors may be operated only after a plurality of individual substrate elements have accumulated in the vacuum lock chamber.

A vacuum pressure in the vacuum drying chamber 460 is created by a vacuum pump 450 connected to the vacuum drying chamber 460 through a condensing chamber 420. The individual substrate elements 438 are conveyed through the vacuum drying chamber by a conveying device 433, such as a conveyor belt or a vibratory conveyor as shown in FIG. 4a. Vacuum pressure within the vacuum drying chamber 460 is controlled by a pressure measurement device 421 and sterile nitrogen gas bleed 417 as described above.

While the individual substrate elements 438 are within the vacuum drying chamber, heat is applied by a heat transfer device 464 to promote sublimation, as described above with reference to FIG. 3. The individual substrate elements 438, with the freeze dried bulk product, are then transferred into a second vacuum lock chamber 436 including a conveying device 434. The pressure barriers 446, 447 are operated similarly to the barriers 444, 445 to transfer the individual substrate elements 438 from vacuum pressure back to atmospheric pressure.

The moisture seal 465 may be applied within the vacuum lock chamber 436, before the pressure in the lock is equalized with atmospheric pressure. Applying the seal within the vacuum lock chamber, as opposed to applying it in the vacuum drying chamber as illustrated in FIG. 3, reduced complexity within the vacuum drying chamber and makes it unnecessary to feed the moisture seal into the vacuum drying chamber under vacuum. For example, a moisture seal such as an overwrap may be fed into the vacuum lock 436 while at atmospheric pressure. The vacuum lock chamber is subsequently evacuated to receive the individual substrate element 438 from the vacuum drying chamber 460. The moisture seal is then applied to the substrate element in the vacuum lock chamber 436 before returning the vacuum lock chamber to atmospheric pressure.

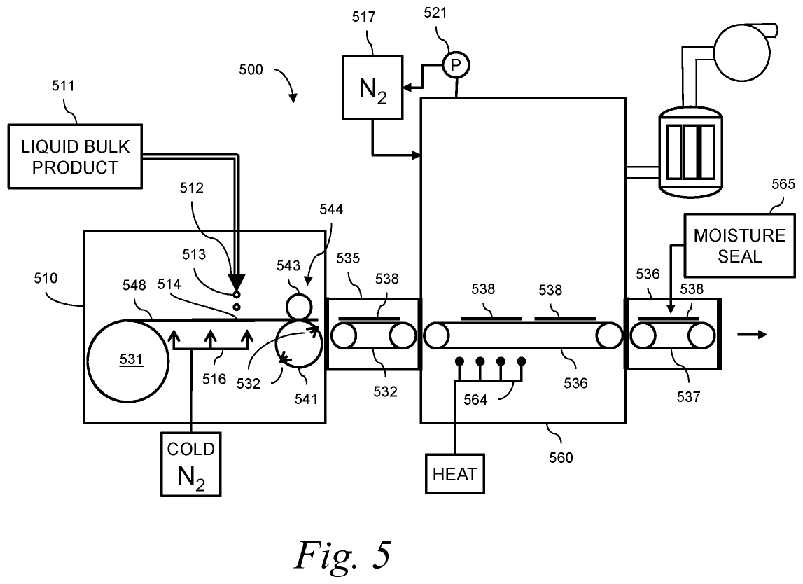

Another system 500 for spray freeze drying on a substrate is shown in FIG. 5. A substrate in the form of a web 548 is fed from a source roll 531 located within the freezing chamber 510. The substrate web 548 is cooled by a cooling apparatus 516 to promote freezing of the bulk product on the substrate. The substrate 548 may be cooled as a web after it is unrolled from the source roll 531. Alternatively, the source roll 531 itself may be cooled before unrolling. As above, the temperature within the freezing chamber 510 is controlled to delay freezing of the bulk product droplets 513 until they impinge on the substrate web 548.

Bulk product including the liquid is fed from one or more sources 511 through inlets 512 to form the droplets 513 within the freezing chamber 510. The droplets 513 impinge on a region 514 of the web. The droplets freeze on the web before the web exits the freezing chamber. The droplets may form a two-dimensional pattern on the web.

Before exiting the freezing chamber, the web 548 passes through a web cutting arrangement 544 that may include an anvil roll 543 and a cutting roll 541 with knives 532. The cutting arrangement 544 separates the substrate web 548 into separate substrate sheets 538. The separate substrate sheets may, for example, be edible dosage sheets bearing frozen pharmaceutical product, the sheets having been separated between groupings of the product. The separate sheets 538 may alternatively be well plates separated from a rolled web of well plates and containing frozen reagents, or transdermal patches bearing frozen pharmaceutical or diagnostic material.

The separated sheets bearing frozen material are transferred to a vacuum lock such as the vacuum lock chamber 535 that includes a conveying device 532 and pressure barriers for equalizing pressure with the vacuum drying chamber 560. The vacuum lock chamber 535 may cycle one time for each separated sheet 538. Alternatively, a plurality of separated sheets 538 may be accumulated in the vacuum lock chamber before the pressure barriers are used to equalize pressure with the vacuum drying chamber.

After pressure is equalized between the vacuum lock chamber 535 and the vacuum drying chamber 560, the separated sheets 538 of substrate are transferred to a conveying device 536 in the vacuum drying chamber. As with the conveying device 433 of FIG. 4, the conveying device 533 of FIG. 5 may be a belt conveyor or may be a vibratory conveyor activated magnetically from outside the vacuum drying chamber. A heat transfer device 564 applies heat to the separated sheets 538 to trigger sublimation of the liquid contained in the bulk product. Vacuum pressure within the vacuum drying chamber 560 is controlled by a pressure measurement device 421 and sterile nitrogen gas bleed 517 as described above. The separated sheets 538 are then transferred to a second vacuum lock chamber 536 and, after pressure is equalized to atmospheric pressure, the separated sheets are discharged by a conveying device 537. As noted above, a moisture sealant 565, an overwrap and/or a skin adhesive may be applied to the product either in the vacuum drying chamber 560 or in the vacuum lock chamber 536.

The freeze drying systems 300, 400, 500 provide the capability of producing a freeze dried product on a substrate without any supplementary operations for transferring the product to the substrate. The presently disclosed systems and methods increase efficiency and reduce the likelihood of contaminating a product.

Because drying is a more time consuming step than freezing, the vacuum drying chambers 360, 460, 560 may be configured to have more capacity than the freezing chambers 310, 420, 530. For example, in embodiments where a web is conveyed through the vacuum drying chamber, the web may follow multiple parallel paths through the vacuum drying chamber before exiting, increasing the drying time. For embodiments wherein separate substrate sections are conveyed through the vacuum drying chamber, parallel conveying devices may be provided in the vacuum drying chamber to move multiple substrate sections at a slower rate than in the freezing chamber.

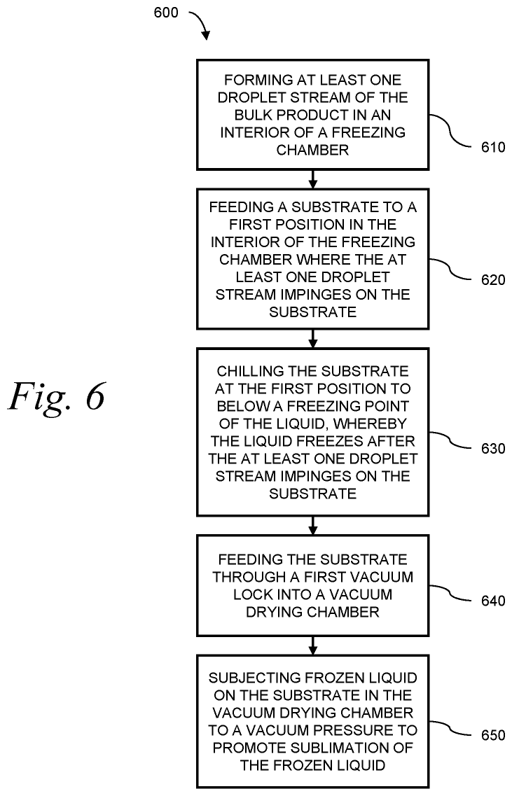

Also presently disclosed and shown schematically in FIG. 6 is a unique freeze drying method 600 for use in freeze drying a liquid-containing bulk product on a substrate. In operation 610, at least one droplet stream of the bulk product is formed in an interior of a freezing chamber. The droplet stream may be formed by using a piezoelectric actuator to drive a piston that changes a cross sectional area of a supply capillary. The at least one droplet stream may comprise droplet streams of at least two different bulk products.

A substrate is fed at operation 620 to a first position in the interior of the freezing chamber. The at least one droplet stream impinges on the substrate at the first position. The formation of the at least one droplet stream of the bulk product and the feeding of the substrate to a first position in the interior of the freezing chamber may be controlled to cause the impingement of the at least one droplet stream on the substrate to form a predefined pattern.

The substrate may be a continuous, flexible substrate at the first position, and may be fed from a roll. The continuous, flexible substrate may be cut into sections after the at least one droplet stream impinges on the substrate. The substrate may alternatively be separate sections that are fed through the freezing chamber using a conveying device such as a vibratory device or a conveyor belt.

The substrate is chilled at operation 630 to below a freezing point of the liquid, whereby the liquid freezes after the at least one droplet stream impinges on the substrate. An ambient temperature inside the freezing chamber may be maintained at a temperature sufficiently high to prevent freezing of the bulk product before it impinges on the substrate. The ambient pressure inside the freezing chamber may be maintained at substantially atmospheric pressure.

In operation 640, the substrate is fed through a first vacuum lock into a vacuum drying chamber. In the case where the substrate comprises separate sections, the first vacuum lock may include a vacuum lock chamber with selectively closable pressure barriers connecting to the freezing chamber and the vacuum drying chamber.

At operation 650, the frozen liquid on the substrate is subjected to a vacuum pressure in the vacuum drying chamber to promote sublimation of the frozen liquid. Heat may be directed to the substrate in the vacuum drying chamber to further promote sublimation of frozen liquid in the bulk product.

A moisture barrier such as a sealing wrapper or a coating may be applied to the substrate and bulk product after sublimation of the frozen liquid. A sealing mechanism to apply the moisture barrier may be located within the vacuum drying chamber.

The method may also include condensing a vapor produced by the sublimation of the frozen liquid in a condensing chamber between vacuum drying chamber and a vacuum pump.

After sublimation of the frozen liquid, the substrate and bulk product may be received in a second vacuum lock. The substrate and bulk product are then returned from the vacuum pressure to atmospheric pressure in the second vacuum lock. A moisture barrier may be applied to the substrate and bulk product within a vacuum lock chamber of the second vacuum lock after sublimation of the frozen liquid.

The foregoing Detailed Description is to be understood as being in every respect illustrative and exemplary, but not restrictive, and the scope of the invention disclosed herein is not to be determined from the Description of the Invention, but rather from the Claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. A freeze drying system for freeze drying a bulk product containing a liquid, comprising:
a freezing chamber;
at least one bulk product inlet directed to an interior of the freezing chamber, the at least one bulk product inlet being connected to a source of the bulk product, the at least one bulk product inlet being configured to create at least one droplet stream of the bulk product in the interior of the freezing chamber;
at least one substrate feeding mechanism configured to feed a substrate to a first position in the interior of the freezing chamber where the at least one droplet stream impinges on the substrate;
a substrate chiller configured to chill the substrate to below a freezing point of the liquid at the first position, whereby the liquid freezes after the at least one droplet stream impinges on the substrate to form a frozen liquid;
a vacuum drying chamber;
a first vacuum lock interconnecting the freezing chamber with the vacuum drying chamber, the at least one substrate feeding mechanism further being configured to feed the substrate through the first vacuum lock to an interior of the vacuum drying chamber; and
a vacuum pump in communication with the vacuum drying chamber for maintaining a vacuum pressure in the vacuum drying chamber to promote sublimation of the frozen liquid.

2. The freeze drying system of claim 1, further comprising:
a freezing chamber temperature controller configured for maintaining an ambient temperature inside the freezing chamber sufficiently high to prevent freezing of the bulk product before impinging on the substrate.

3. The freeze drying system of claim 1, further comprising:
a freezing chamber pressure controller configured for maintaining an ambient pressure inside the freezing chamber at substantially atmospheric pressure.

4. The freeze drying system of claim 1, wherein the at least one bulk product inlet directed to the interior of the freezing chamber further comprises:
a piston driven by a piezoelectric actuator to change cross sectional area of a supply capillary and create the droplet stream.

5. The freeze drying system of claim 1, wherein the at least one substrate feeding mechanism feeds a continuous, flexible substrate past the first position.

6. The freeze drying system of claim 5, wherein the at least one substrate feeding mechanism further comprises:
a cutting mechanism within the freezing chamber, the cutting mechanism configured for cutting the continuous, flexible substrate into sections.

7. The freeze drying system of claim 6, wherein the at least one substrate feeding mechanism is further configured to feed the sections through the first vacuum lock to the interior of the vacuum drying chamber.

8. The freeze drying system of claim 1, further comprising:
a heater in the vacuum drying chamber configured to direct heat to the substrate to further promote sublimation of frozen liquid in the bulk product.

9. The freeze drying system of claim 1, further comprising:
a sealing mechanism for applying a moisture barrier to the substrate and bulk product after sublimation of the frozen liquid.

10. The freeze drying system of claim 9, wherein the moisture barrier is a sealing wrapper.

11. The freeze drying system of claim 9, wherein the moisture barrier is a coating.

12. The freeze drying system of claim 9, wherein the sealing mechanism is located within the vacuum drying chamber.

13. The freeze drying system of claim 1, further comprising:
a second vacuum lock including a vacuum lock chamber positioned for receiving the substrate and bulk product after sublimation of the frozen liquid and configured for returning the substrate and bulk product from the vacuum pressure to atmospheric pressure.

14. The freeze drying system of claim 13, further comprising:
a sealing mechanism located within the vacuum lock chamber of the second vacuum lock for applying a moisture barrier to the substrate and bulk product after sublimation of the frozen liquid.

15. The freeze drying system of claim 1, further comprising:
a condensing chamber between vacuum drying chamber and the vacuum pump for condensing vapor produced by the sublimation of the frozen liquid.

16. The freeze drying system of claim 1:
wherein the at least one bulk product inlet directed to an interior of the freezing chamber comprises an array of bulk product inlets; and
a controller configured for controlling the array of bulk product inlets and the at least one substrate feeding mechanism whereby the impingement of the at least one droplet stream on the substrate forms a predefined pattern.

17. The freeze drying system of claim 1, wherein the at least one bulk product inlet comprises a first bulk product inlet configured to create a droplet stream of a first bulk product, and a second bulk product inlet configured to create a droplet stream of a second bulk product.

18. A method for freeze drying a bulk product containing a liquid, comprising:
forming at least one droplet stream of the bulk product in an interior of a freezing chamber;
feeding a substrate to a first position in the interior of the freezing chamber where the at least one droplet stream impinges on the substrate;
chilling the substrate at the first position to below a freezing point of the liquid, whereby the liquid freezes to produce a frozen liquid on the substrate after the at least one droplet stream impinges on the substrate;
feeding the substrate through a first vacuum lock into a vacuum drying chamber; and
subjecting the substrate in the vacuum drying chamber to a vacuum pressure to promote sublimation of the frozen liquid.

19. The method of claim 18, further comprising:
maintaining an ambient temperature inside the freezing chamber sufficiently high to prevent freezing of the bulk product before impinging on the substrate.

20. The method of claim 18, further comprising:
maintaining an ambient pressure inside the freezing chamber at substantially atmospheric pressure.

21. The method of claim 18, further comprising:
driving a piston by a piezoelectric actuator to change a cross sectional area of a supply capillary to create the at least one droplet stream of the bulk product.

22. The method of claim 18, wherein the substrate is a continuous, flexible substrate at the first position.

23. The method of claim 22, further comprising:
cutting the continuous, flexible substrate into sections after the at least one droplet stream impinges on the substrate.

24. The method of claim 23, further comprising:
feeding the sections through the first vacuum lock into the vacuum drying chamber.

25. The method of claim 18, further comprising:
directing heat to the substrate in the vacuum drying chamber to further promote sublimation of frozen liquid in the bulk product.

26. The method of claim 18, further comprising:
applying a moisture barrier to the substrate and bulk product after sublimation of the frozen liquid.

27. The method of claim 26, wherein the moisture barrier is a sealing wrapper.

28. The method of claim 26, wherein the moisture barrier is a coating.

29. The method of claim 26, wherein the sealing mechanism is located within the vacuum drying chamber.

30. The method of claim 18, further comprising:
receiving the substrate and bulk product in a second vacuum lock including a vacuum lock chamber after sublimation of the frozen liquid; and
returning the substrate and bulk product from the vacuum pressure to atmospheric pressure in the vacuum lock chamber of the second vacuum lock.

31. The method of claim 30, further comprising:
applying a moisture barrier to the substrate and bulk product within the vacuum lock chamber of the second vacuum lock.

32. The method of claim 18, further comprising:
condensing vapor produced by the sublimation of the frozen liquid in a condensing chamber between the vacuum drying chamber and a vacuum pump.

33. The method of claim 18, further comprising:
controlling the forming of the at least one droplet stream of the bulk product and controlling the feeding of the substrate to a first position in the interior of the freezing chamber whereby the impingement of the at least one droplet stream on the substrate forms a predefined pattern.

34. The method of claim 18, wherein forming the at least one droplet stream of the bulk product further comprises:
forming a first droplet stream of a first product; and
forming a second droplet stream of a second product.

35. The method of claim 18, further comprising:
controlling the vacuum pressure in the vacuum drying chamber by rotating a vacuum pump in communication with the vacuum drying chamber at substantially constant speed while controlling nitrogen gas bleed into the vacuum drying chamber.
